(19) United States
(12) Patent Application Publication
(10) Pub. No.: US 2017/0148409 A1
(43) Pub. Date: May 25, 2017

(54) LIQUID CRYSTAL DISPLAY PANEL AND DRIVING METHOD THEREOF

(71) Applicant: Shenzhen China Star Optoelectronics Technology Co., Ltd., Shenzhen, Guangdong (CN)

(72) Inventor: Bo Sun, Shenzhen, Guangdong (CN)

(73) Assignee: Shenzhen China Star Optoelectronics Technology Co., Ltd., Shenzhen, Guangdong (CN)

(21) Appl. No.: 14/785,986

(22) PCT Filed: Jun. 17, 2015
(86) PCT No.: PCT/CN2015/081673

§ 371 Date: Dec. 31, 2015

(30) Foreign Application Priority Data
May 26, 2015 (CN) 201510273789.2

(51) Int. Cl. G09G 3/36; G02F 1/1343; G02F 1/1368; G02F 1/1362

(52) U.S. Cl. CPC G09G 3/3696; G09G 3/3677; G09G 3/3688; G02F 1/136286; G02F 1/134309; G02F 1/1368; G09G 2300/0426; G09G 2310/0251; G09G 2320/0247; G09G 2320/0242; G02F 2201/121; G02F 2001/134345

(57) ABSTRACT

A liquid crystal display panel is disclosed. The liquid crystal display panel comprises a plurality of pixel units, wherein each pixel unit is composed of a first sub pixel unit with a first pixel voltage and a second sub pixel unit with a second pixel voltage which use a same data line while different scanning lines respectively; and wherein the second sub pixel unit is driven during a driving period of the first sub pixel unit. According to the present disclosure, the influence of a second coupling voltage on the LCD during alternating current driving process can be eliminated.

### CROSS REFERENCE TO RELATED APPLICATION

The present application claims benefit of Chinese patent application CN 201510273789.2, entitled “Liquid Crystal Display Panel and Driving Method Thereof” and filed on May 26, 2015, the entirety of which is incorporated herein by reference.

### FIELD OF THE INVENTION

The present disclosure relates to the technical field of liquid crystal display device, and particularly to a liquid crystal display panel and a driving method thereof.

### BACKGROUND OF THE INVENTION

In recent years, the Vertical Alignment (VA) Liquid Crystal Display (LCD) has been increasingly used by virtue of its advantages of wide viewing angle, high picture contrast, and free of friction alignment. In a VA LCD, the negative liquid crystal molecules in a vertical state would tilt by the action of the voltage applied between the two substrates through dividing the liquid crystal layer into several domains, so that the viewing angle of the LCD can be improved, and the color shift problem thereof can be alleviated.

Since only four-domain display can be realized physically at most, eight-domain display of the LCD is generally realized through controlling the rotation angle Φ of the liquid crystal molecules. FIG. 1 schematically shows a structure of a pixel unit of a liquid crystal display panel with eight-domain display in the prior art. The pixel unit is further divided into two sub pixel units, and the principle of eight-domain display thereof will be illustrated below. First, storage capacitors Cₛₜ₋₁ and Cₛₜ₋₂ are charged with a same voltage through switching elements TFT1 and TFT2, which are Thin Film Transistors, of the pixel unit which are connected with a same scanning line and a same data line. Then, the switching elements TFT1 and TFT2 are both turned off while a switching element TFT3 is turned on. In this case, the storage capacitor Cₛₜ₋₂ would discharge through a circuit formed by TFT3 and a capacitor C_{down}, so that a pixel voltage of the sub pixel unit which contains Cₛₜ₋₂ can be reduced. Under such circumstances, the rotation angle Φ of the liquid crystal molecules of one sub pixel unit is different from that of the other sub pixel unit, and thus the eight-domain display can be realized. Therefore, the viewing angle of large sized LCD can be improved, and the color shift problem thereof can be alleviated. However, in practical applications, the image flicker and image spiking problems would exist in the LCD which is driven through the above method.

In a word, in order to solve the aforesaid technical problem, a new method through which eight-domain display of the LCD can be realized is urgently needed.

### SUMMARY OF THE INVENTION

The present disclosure aims to provide a new method to realize eight-domain display of the LCD.

In order to solve the aforesaid technical problem, the embodiment of the present disclosure first provides a liquid crystal display panel, comprising an array substrate which is provided with a plurality of scanning lines, a plurality of data lines, and a plurality of pixel units, each pixel unit being composed of a first sub pixel unit and a second sub pixel unit which use a same data line while different scanning lines respectively,

wherein the first sub pixel unit is turned on by a scanning voltage of a first scanning line, receives a data signal of the data line, and has a first pixel voltage;

wherein the second sub pixel unit is turned on by a scanning voltage of a second scanning line during a driving period of the first sub pixel unit, receives a data signal of the data line, and has a second pixel voltage; and

wherein the second sub pixel unit is driven during the driving period of the first sub pixel unit.

Preferably, said first sub pixel unit comprises a first switching element and a first storage capacitor; said first switching element comprises a control end, a signal input end, and a signal output end, said control end being electrically connected with said first scanning line, said signal input end being electrically connected with said data line, and said signal output end being electrically connected with one end of said first storage capacitor; and the other end of said first storage capacitor is electrically connected with a common electrode.

Preferably, said second sub pixel unit comprises a second switching element and a second storage capacitor; said second switching element comprises a control end, a signal input end, and a signal output end, said control end being electrically connected with said second scanning line, said signal input end being electrically connected with said data line, and said signal output end being electrically connected with one end of said second storage capacitor; and the other end of said second storage capacitor is electrically connected with the common electrode.

Preferably, said switching element comprises a thin film transistor.

Preferably, an area of said first sub pixel unit is less than an area of said second sub pixel unit.

The embodiment of the present disclosure further provides a method for driving the liquid crystal display panel, and said method comprises the following steps:

a first step, turning on a first sub pixel unit with a scanning voltage of a first scanning line, and charging said first sub pixel unit with a data signal of a data line, so that said first sub pixel unit reaches a first pixel voltage; and

a second step, turning on a second sub pixel unit with a scanning voltage of a second scanning line during a driving period of the first sub pixel unit, and charging said second sub pixel unit with a data signal of the data line, so that said second sub pixel unit reaches a second pixel voltage, wherein the second sub pixel unit is driven during the driving period of the first sub pixel unit.

Preferably, the driving period of said first sub pixel unit is determined by a rotation angle of liquid crystal molecules in said first sub pixel unit, and a driving period of said second sub pixel unit is determined by a rotation angle of liquid crystal molecules in said second sub pixel unit.

Preferably, the driving period of said second sub pixel unit is three quarters of the driving period of said first sub pixel unit.

Preferably, the scanning voltage of said first scanning line is equal to the scanning voltage of said second scanning line.

Preferably, the method further comprises adjusting an electric potential of a common electrode according to a first coupling voltage.

Compared with the prior art, one embodiment or a plurality of embodiments according to the present disclosure may have the following advantages or beneficial effects.

In the liquid crystal display panel according to the present disclosure, the influence of a second coupling voltage on the LCD during alternating current (AC) driving can be eliminated through using a pixel unit structure comprising two sub pixel units which share a same data line but use different scanning lines respectively, whereby the aperture ratio of the pixel unit can be increased, and the display effect of the LCD can be improved.

Other advantages, objectives, and features of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings provide further understandings of the present disclosure or the prior art, and constitute one part of the description. The drawings are used for interpreting the present disclosure together with the embodiments, not for limiting the present disclosure. In the drawings:

FIG. 1 schematically shows a structure of a pixel unit of a liquid crystal display panel with eight-domain display in the prior art;

FIG. 2 schematically shows a structure of a pixel unit of a liquid crystal display panel according to an embodiment of the present disclosure;

FIG. 3 is a flow chart of a method for driving the liquid crystal display panel according to the embodiment of the present disclosure; and

FIG. 4 is a driving time-sequence diagram of the liquid crystal display panel according to the embodiment of the present disclosure.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that, as long as there is no structural conflict, all the technical features mentioned in all the embodiments may be combined together in any manner, and the technical solutions obtained in this manner all fall within the scope of the present disclosure.

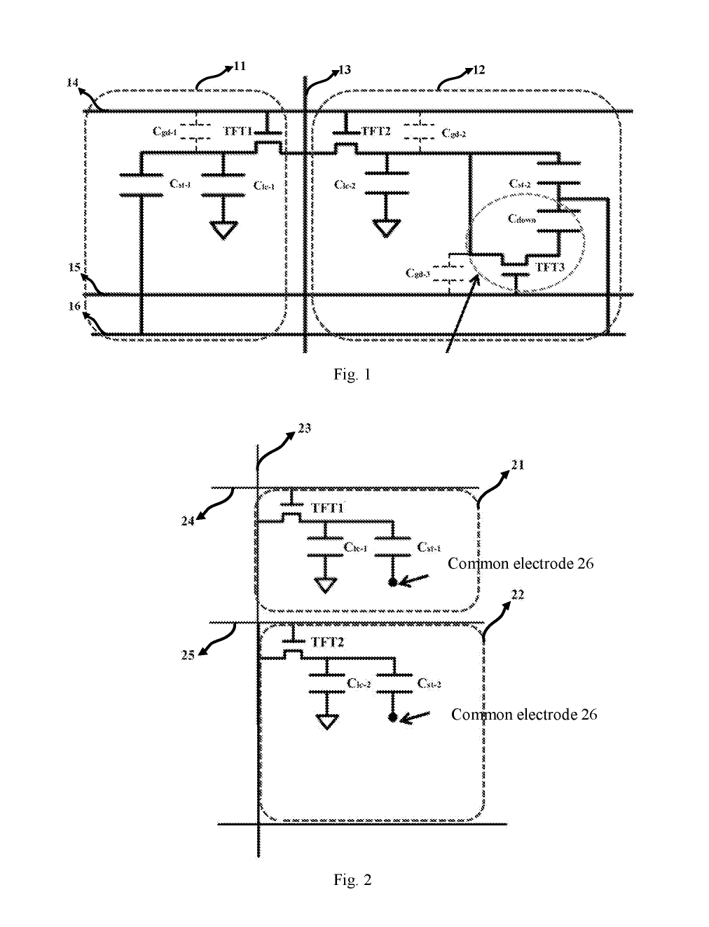

It can be discovered through analyzing a structure of a pixel unit as shown in FIG. 1 that, the main reason for image flicker and image spiking of the LCD is the influence of a parasite capacitor of a switching element TFT3, which will be illustrated in detail below with reference to FIG. 1.

The pixel unit as shown in FIG. 1 is divided into two sub pixel units, which are shown by two regions surrounded by two rectangular dotted line boxes in FIG. 1. Specifically, a sub pixel unit 11 comprises a switching element TFT1 and a storage capacitor Cₛₜ₋₁. In addition, an equivalent liquid crystal capacitor C_{1c-1} of a liquid crystal layer arranged between two substrates is also shown in the sub pixel unit 11. A sub pixel unit 12 comprises a switching element TFT2 and a storage capacitor Cₛₜ₋₂. Similarly, an equivalent liquid crystal capacitor C_{1c-2} of a liquid crystal layer arranged between the two substrates is also shown in the sub pixel unit 12. Moreover, the sub pixel unit 12 is further provided with a switching element TFT3 and a sharing capacitor C_{down}. The specific procedure of eight-domain display of the pixel unit will be illustrated below. First, the switching elements TFT1 and TFT2 are both turned on by a scanning line 14, and the storage capacitors Cₛₜ₋₁ and Cₛₜ₋₂ are both charged to a same voltage by a data line 13 through TFT1 and TFT2 respectively. At this time, since a pixel voltage which is applied to liquid crystal pixels in the sub pixel unit 11 is equal to that which is applied to liquid crystal pixels in the sub pixel unit 12, a rotation angle Φ of the liquid crystal molecules in the sub pixel unit 11 is the same as that of the liquid crystal molecules in the sub pixel unit 12. When the charging procedure is completed, the scanning line 14 is returned to a low-level voltage, and the switching elements TFT1 and TFT2 are both turned off. Then, the switching element TFT3 in the sub pixel unit 12 is turned on by a sharing scanning line 15, and thus the sharing capacitor C_{down} and the storage capacitor Cₛₜ₋₂ are in parallel connection with each other. At the same time, the sharing capacitor C_{down} is charged by the storage capacitor Cₛₜ₋₂, and thus the voltage of the storage capacitor Cₛₜ₋₂ drops. At this time, the pixel voltage which is applied to the liquid crystal pixels in the sub pixel unit 11 is higher than that which is applied to the liquid crystal pixels in the sub pixel unit 12, and thus the rotation angle Φ of the liquid crystal molecules in the sub pixel unit 11 is different from that of the liquid crystal molecules in the sub pixel unit 12, whereby the eight-domain display of the LCD can be realized.

Further, in order to display the images in a correct manner, in the LCD which is driven through an alternating current driving method, a certain compensation shall be performed with respect to coupling voltages V_{ft} caused by parasite capacitors. Specifically, as shown in FIG. 1, when TFT1 and TFT2 are both turned on, the voltage of the storage capacitors Cₛₜ₋₁ and Cₛₜ₋₂ would be influenced by the scanning voltage of the scanning line 14 through a parasite capacitor C_{gd-1} of TFT1 and a parasite capacitor C_{gd-2} of TFT2, which can be referred to as an influence of a first coupling voltage V_{ft-1}.

When TFT1 and TFT2 are both turned off while TFT3 is turned on, the voltage of the storage capacitor Cₛₜ₋₂ would be influenced by the scanning voltage of the sharing scanning line 15 through the parasite capacitor C_{gd-3} of TFT3, which can be referred to as an influence of a second coupling voltage V_{ft-2}.

In the prior art, with respect to the coupling voltage, the compensation is performed on the two sub pixel units synchronously. However, the second coupling voltage V_{ft-2} only has influence on the storage capacitor Cₛₜ₋₂, which is disposed in the sub pixel unit 12. Therefore, when there is the second coupling voltage in the sub pixel unit 12, the compensation amount with respect to the coupling voltage in the sub pixel unit 11 would be different from that with respect to the coupling voltage in the sub pixel unit 12. Consequently, when the LCD is driven through the alternating current driving method, the voltage of a gray-scale corresponding to a positive voltage and the voltage of the same gray-scale corresponding to a negative voltage thereof would be different from each other, and image flicker would exist on the LCD.

In order to solve the aforesaid technical problem, the embodiment of the present disclosure provides a new liquid crystal display panel, which comprises an array substrate, and the array substrate is provided with a plurality of scanning lines, a plurality of data lines, and a plurality of pixel units. A structure of each pixel unit is shown in FIG. 2. Each pixel unit is composed of a first sub pixel unit and a second sub pixel unit which use a same data line while different scanning lines respectively. The first sub pixel unit is turned on by a scanning voltage of a first scanning line, receives a data signal of the data line, and has a first pixel voltage. The second sub pixel unit is turned on by a scanning voltage of a second scanning line during a driving period of the first sub pixel unit, receives a data signal of the data line, and has a second pixel voltage.

Each sub pixel unit is driven by a scanning line, while two sub pixel units of each pixel unit are driven by a same data line. Specifically, a first sub pixel unit 21 comprises a first switching element TFT1 and a first storage capacitor Cₛₜ₋₁. A control end of the first switching element TFT1 is electrically connected with a first scanning line 24, a signal input end of TFT1 is electrically connected with a data line 23, a signal output end of TFT1 is electrically connected with one end of the first storage capacitor Cₛₜ₋₁, and the other end of the first storage capacitor Cₛₜ₋₁ is electrically connected with a common electrode 26. A second sub pixel unit 22 comprises a second switching element TFT2 and a second storage capacitor Cₛₜ₋₂. A control end of the second switching element TFT2 is electrically connected with a second scanning line 25, a signal input end of TFT2 is electrically connected with the data line 23, a signal output end of TFT2 is electrically connected with one end of the second storage capacitor Cₛₜ₋₂, and the other end of the second storage capacitor Cₛₜ₋₂ is electrically connected with the common electrode 26. In addition, the equivalent liquid crystal capacitors C_{1c-1} and C_{1c-2} of the liquid crystal layer between the two substrates are shown in the first sub pixel unit 21 and the second sub pixel unit 22 respectively. One ends of the liquid crystal capacitors C_{1c-1} and C_{1c-2} are connected with the signal output ends of TFT1 and TFT2 respectively, and the other ends thereof are electrically connected with a common electrode. It should be noted that, the wirings of the common electrode 26 are not shown in FIG. 2. The common electrode which is connected with the storage capacitors Cₛₜ₋₁ and Cₛₜ₋₂ is arranged on the array substrate, the common electrode which is connected with the liquid crystal capacitors C_{1c-1} and C_{1c-2} is arranged on another substrate, and the two common electrodes have a same electric potential.

It should be noted that, in the aforesaid pixel unit, an area of the first sub pixel unit is less than an area of the second sub pixel unit. For example, when the area of the second sub pixel unit is about twice as that of the first sub pixel unit, a better display effect can be obtained, i.e., the color shift phenomenon can be alleviated satisfactorily.

According to the embodiment of the present disclosure, since the switching element TFT3, the sharing capacitor C_{down}, and the branch circuits thereof are all omitted, no parasite capacitor C_{gd-3} exists any longer. That is, the influence of the second coupling voltage V_{ft-2} can be eliminated.

According to the embodiment of the present disclosure, one plates of the first storage capacitor Cₛₜ₋₁ and the liquid crystal capacitor C_{1c-1} in the first sub pixel unit as well as the second storage capacitor Cₛₜ₋₂ and the liquid crystal capacitor C_{1c-2} in the second sub pixel unit are connected with a corresponding common electrode respectively, so that the coupling voltages generated therein would not superpose with one another and the mutual influence of the parasite capacitors can be reduced. It can be seen in the following that, the structure of the pixel unit according to the embodiment of the present disclosure would facilitate the compensation on the first coupling voltage V_{ft-1}.

Further, the technical procedures for manufacturing the array substrate can be simplified by the improvement of the structure of the pixel unit, and thus the production efficiency of the substrate as well as the reliability thereof can be improved. The aperture ratio of the second sub pixel unit can be increased by the improvement of the structure of the pixel unit, and thus the display effect of the LCD can be improved.

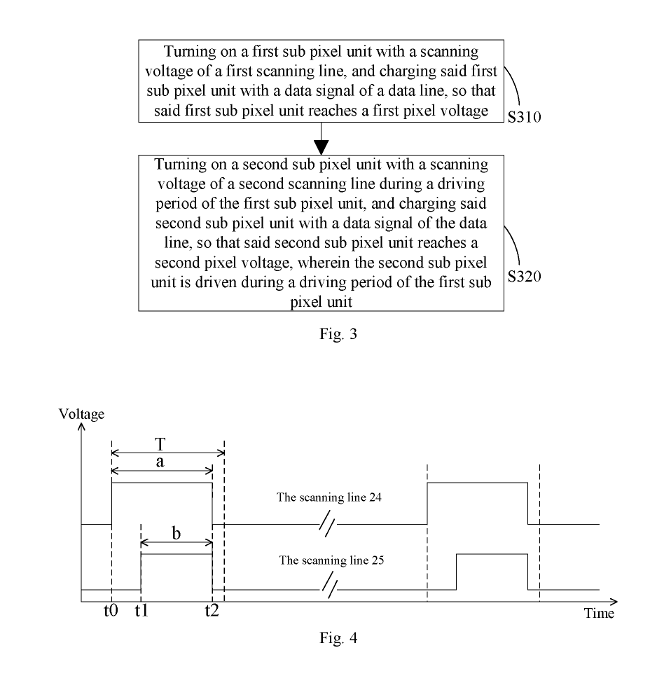

Based on the structure of the pixel unit as shown in FIG. 2, the embodiment of the present disclosure further provides a method for driving the liquid crystal display panel. The method will be illustrated below with reference to FIGS. 3 and 4.

FIG. 3 is a flow chart of a method for driving the liquid crystal display panel according to the embodiment of the present disclosure. FIG. 4 is a driving time-sequence diagram of the liquid crystal display panel according to the embodiment of the present disclosure. As shown in FIG. 3, the method according to the embodiment of the present disclosure comprises the following steps. In step S310, a first sub pixel unit is turned on by a scanning voltage of a first scanning line and charged by a data signal of a data line, so that the first sub pixel unit reaches a first pixel voltage. In step S320, during a driving period of the first sub pixel unit, a second sub pixel unit is turned on by a scanning voltage of a second scanning line and charged by the data signal of the data line, so that the second sub pixel unit reaches a second pixel voltage.

The second sub pixel unit is driven during a driving period of the first sub pixel unit.

It can be seen from the charge conservation law that, when a voltage or electric current through which a capacitor is charged is constant, the electric quantity obtained by the capacitor is determined by the charging time. In the driving method according to the embodiment of the present disclosure, different pixel voltages can be obtained through regulating the charging times of the first storage capacitor Cₛₜ₋₁ and the second storage capacitor Cₛₜ₋₂. Further, a driving period of the first sub pixel unit is determined by a rotation angle Φ1 of liquid crystal molecules in the first sub pixel unit, and a driving period of the second sub pixel unit is determined by a rotation angle Φ2 of liquid crystal molecules in the second sub pixel unit.

As shown in FIG. 4, the storage capacitors of the first sub pixel unit and the second sub pixel unit are charged during a valid addressing period T. The valid addressing period means a permitted turned-on time of each pixel unit that is determined by the pixels of the LCD and a refresh rate of each frame image. For example, when a resolution of a LCD is 1024*768, the permitted turned-on time of each row of pixel units is 21.7 μs, and thus the valid addressing period is 21.7 μs. Specifically, at t0 moment, the scanning voltage is applied to the first scanning line 24, and the first switching element TFT1 in the first sub pixel unit is turned on by the scanning voltage. At the same time, the first storage capacitor Cₛₜ₋₁ is charged by the signal voltage of the data line 23. Further, during the time period when the first sub pixel unit is driven by the first scanning line 24, such as at t1 moment, the scanning voltage is applied to the second scanning line 25, and the second switching element TFT2 in the second sub pixel unit is turned on by the scanning voltage. At the same time, the second storage capacitor Cₛₜ₋₂ is charged by the signal voltage of the data line 23. The scanning voltage of the first scanning line 24 is equal to that of the second scanning line 25, and the scanning voltages both return to a low-level state at t2 moment, so that the charging of the storage capacitors Cₛₜ₋₁ and Cₛₜ₋₂ is completed.

It should be noted that, according to the embodiment of the present disclosure, the moment when the charging of the second storage capacitor Cₛₜ₋₂ begins would not be restricted, as long as the condition that the second sub pixel unit is driven during a driving period of the first sub pixel unit is guaranteed. Further, step S310 and step S320 can be performed at the same time. For example, in FIG. 4, TFT1 and TFT2 can also be turned on by the scanning voltages of the first scanning line 24 and the second scanning line 25 at t0 moment, and TFT2 is turned off at t0+b moment prior to TFT1. Or TFT2 can be turned on at a moment between t0 and t1 by the second scanning line 25 and turned off prior to TFT1.

According to the embodiment of the present disclosure, a driving period of the first sub pixel unit is larger than a driving period of the second sub pixel unit. For example, the driving period b of the second sub pixel unit can be three quarters of the driving period a of the first sub pixel unit. In this case, an illumination of per unit area of the first sub pixel unit is higher than an illumination of per unit area of the second sub pixel unit, and a better display effect can be obtained.

The method according to the embodiment of the present disclosure can be used for driving a liquid crystal display panel with a high resolution. In the prior art, TFT3 is turned on so that the second storage capacitor Cₛₜ₋₂ discharges after the first storage capacitor Cₛₜ₋₁ and the second storage capacitor Cₛₜ₋₂ are charged. It can be seen from the above analysis that, since the driving of one pixel unit needs to be completed during one valid addressing period, the charging time of TFT1 and TFT2 is limited.

However, according to the embodiment of the present disclosure, since the second sub pixel unit is driven during the driving period of the first sub pixel unit, the first sub pixel unit and the second sub pixel unit will not occupy respective valid addressing periods. Further, when the driving process of the first sub pixel unit (which contains the driving process of the second sub pixel unit) does not need to occupy the total valid addressing period, more pixel units can be driven by the present driving module, and thus the resolution of the LCD can be improved.

The method according to the embodiment of the present disclosure further comprises the step of adjusting an electric potential of a common electrode according to a first coupling voltage V_{ft-1}. It can be seen from the above analysis that, according to the embodiment of the present disclosure, one plates of the storage capacitor Cₛₜ₋₁ and the liquid crystal capacitor C_{1c-1} in the first sub pixel unit as well as the storage capacitor Cₛₜ₋₂ and the liquid crystal capacitor C_{1c-2} in the second sub pixel unit are connected with a corresponding common electrode respectively, whereby the influence of the first coupling voltage can be compensated through regulating the electric potential V_{com}, of the common electrodes. Further, according to the embodiment of the present disclosure, the asymmetrical positive frame images and negative frame images during alternating current driving process can be compensated through regulating the electric potential V_{com} of the common electrodes. Therefore, the pixel units do not need to be driven by a complicated multi-stage driving method, while only need to be driven by a two-stage driving method to achieve a satisfactory display effect. Moreover, since there are only two different voltage values in the scanning line (i.e., the voltage by which the transistor is turned on and the voltage by which the transistor is turned off), and the two voltage values in the first scanning line 24 are equal to those in the second scanning line 25 correspondingly, the first coupling voltage generated in the first sub pixel unit is roughly equal to that generated in the second sub pixel unit. Therefore, the difference between the compensation amounts of V_{com} of the first sub pixel unit and the second sub pixel unit can be further reduced, which would facilitate the improvement of display effect of the LCD.

At last, it should be noted that, in the method according to the embodiment of the present disclosure, although one pixel unit is driven by two scanning lines, the second sub pixel unit is driven during the driving period of the first sub pixel unit. Therefore, only minor modifications need to be made to the Gate Integrated Circuit (IC) that is driven by a single scanning line in the prior art when designing the driving module of scanning lines, so that the driving module can output another waveform with a different width on the basis of the traditional waveform. During this process, no complicated time-sequence design needs to be taken into consideration, and thus the development time of new products can be shortened.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. A liquid crystal display panel, comprising an array substrate which is provided with a plurality of scanning lines, a plurality of data lines, and a plurality of pixel units, each pixel unit being composed of a first sub pixel unit and a second sub pixel unit which use a same data line while different scanning lines respectively,
wherein the first sub pixel unit is turned on by a scanning voltage of a first scanning line, receives a data signal of the data line, and has a first pixel voltage;
wherein the second sub pixel unit is turned on by a scanning voltage of a second scanning line during a driving period of the first sub pixel unit, receives a data signal of the data line, and has a second pixel voltage; and
wherein the second sub pixel unit is driven during the driving period of the first sub pixel unit.

2. The liquid crystal display panel according to claim 1,
wherein said first sub pixel unit comprises a first switching element and a first storage capacitor;
wherein said first switching element comprises a control end, a signal input end, and a signal output end, said control end being electrically connected with said first scanning line, said signal input end being electrically connected with said data line, and said signal output end being electrically connected with one end of said first storage capacitor; and
wherein the other end of said first storage capacitor is electrically connected with a common electrode.

3. The liquid crystal display panel according to claim 2,
wherein said second sub pixel unit comprises a second switching element and a second storage capacitor;
wherein said second switching element comprises a control end, a signal input end, and a signal output end, said control end being electrically connected with said second scanning line, said signal input end being electrically connected with said data line, and said signal output end being electrically connected with one end of said second storage capacitor; and
wherein the other end of said second storage capacitor is electrically connected with the common electrode.

4. The liquid crystal display panel according to claim 2, wherein said switching element comprises a thin film transistor.

5. The liquid crystal display panel according to claim 3, wherein said switching element comprises a thin film transistor.

6. The liquid crystal display panel according to claim 1, wherein an area of said first sub pixel unit is less than an area of said second sub pixel unit.

7. A method for driving a liquid crystal display panel,
wherein said liquid crystal display panel comprises an array substrate which is provided with a plurality of scanning lines, a plurality of data lines, and a plurality of pixel units, each pixel unit being composed of a first sub pixel unit and a second sub pixel unit which use a same data line while different scanning lines respectively,
wherein the first sub pixel unit is turned on by a scanning voltage of a first scanning line, receives a data signal of the data line, and has a first pixel voltage;
wherein the second sub pixel unit is turned on by a scanning voltage of a second scanning line during a driving period of the first sub pixel unit, receives a data signal of the data line, and has a second pixel voltage; and
wherein the second sub pixel unit is driven during the driving period of the first sub pixel unit; and
wherein said method comprises the following steps:
a first step, turning on a first sub pixel unit with a scanning voltage of a first scanning line, and charging said first sub pixel unit with a data signal of the data line, so that said first sub pixel unit reaches a first pixel voltage; and
a second step, turning on a second sub pixel unit with a scanning voltage of a second scanning line during a driving period of the first sub pixel unit, and charging said second sub pixel unit with a data signal of the data line, so that said second sub pixel unit reaches a second pixel voltage, wherein the second sub pixel unit is driven during the driving period of the first sub pixel unit.

8. The method according to claim 7, wherein the driving period of said first sub pixel unit is determined by a rotation angle of liquid crystal molecules in said first sub pixel unit, and a driving period of said second sub pixel unit is determined by a rotation angle of liquid crystal molecules in said second sub pixel unit.

9. The method according to claim 8, wherein the driving period of said second sub pixel unit is three quarters of the driving period of said first sub pixel unit.

10. The method according to claim 7, wherein the scanning voltage of said first scanning line is equal to the scanning voltage of said second scanning line.

11. The method according to claim 7, further comprising adjusting an electric potential of a common electrode according to a first coupling voltage before the first step.
